(19) United States
(12) Patent Application Publication
(10) Pub. No.: US 2026/0063285 A1
(43) Pub. Date: Mar. 5, 2026

(54) PORTABLE WORK LIGHT

(71) Applicant: ISM LIGHITING, LLC, East Providence, RI (US)

(72) Inventor: Nicholas Blount Palumbo, Key Biscayne, FL (US)

(73) Assignee: ISM LIGHTING, LLC, East Providence, RI (US)

(21) Appl. No.: 19/256,836

(22) Filed: Jul. 1, 2025

Related U.S. Application Data
(60) Provisional application No. 63/666,616, filed on Jul. 1, 2024.

(51) Int. Cl. F21V 21/14; F21V 3/02; F21V 21/06; F21V 21/22; F21V 23/06; F21V 29/60; F21V 31/03; F21Y 115/10

(52) U.S. Cl. CPC F21V 21/145; F21V 3/026; F21V 21/06; F21V 21/22; F21V 23/06; F21V 29/60; F21V 31/03; F21Y 2115/10

(57) ABSTRACT

A portable work light includes a balloon light resting on a set of collapsible telescoping poles locked together by a locking clamp, a turtle shell housing, a lower collapsible telescoping pole engaged within a cavity of the turtle shell housing, a tube, the turtle shell housing configured to ride up and down on the tube, and legs pivotally attached to bottom ends of the turtle shell and fanned out from the tube, the turtle shell housing configured to receive collapsed collapsible telescoping poles when the clamp is unlocked, receive the balloon light resting on the set of collapsible telescoping poles, and receive the legs in a collapsed state.

### CROSS REFERENCE TO RELATED APPLICATIONS

This application claims benefit from U.S. Provisional Patent Application Ser. No. 63/666,616, filed Jul. 1, 2024, which is incorporated by reference in its entirety.

### BACKGROUND OF THE INVENTION

The present invention relates generally to lighting, and more particularly to a portable work light.

In general, a balloon light fixture/lamp with an inflatable diffuser can light up a large area with diffused light, eliminating glare or significantly reducing intensity and dazzle, improving vision clarity for the benefit of a user's safety and productivity.

A good portable light needs to be easy to set up and take down.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a portable work light including a balloon light fixture/lamp with an inflatable diffuser resting on a set of collapsible telescoping poles locked together by a locking clamp, a turtle shell housing, a lower collapsible telescoping pole engaged within a cavity of the turtle shell housing, a tube, the turtle shell housing configured to ride up and down on the tube, and legs pivotally attached to bottom ends of the turtle shell and fanned out from the tube, the turtle shell housing configured to receive collapsed collapsible telescoping poles when the clamp is unlocked, receive the balloon light fixture/lamp with an inflatable diffuser resting on the set of collapsible telescoping poles, and receive the legs in a collapsed state.

In another aspect, the invention features a portable lighting system including a balloon light fixture/lamp with an inflatable diffuser mounted on a telescoping mast, and a turtle shell housing with a cavity to enclose and protect the balloon light fixture/lamp with an inflatable diffuser when in a collapsed state.

In still another aspect, the invention features a turtle shell housing including an upper cavity configured to receive and protect a balloon light fixture/lamp with an inflatable diffuser mounted on a telescopic tube in a collapsed position and support the balloon light fixture/lamp with an inflatable diffuser on the telescopic tube in a deployed position, a lower cavity configured to receive a hex tube, and leg attachments positioned around a lower perimeter.

In yet another aspect, the invention features a turtle shell housing including a solid cylindrical structure configured to shield a balloon light fixture/lamp with an inflatable diffuser fixture/lamp with an inflatable diffuser when in a retracted position, and store a two-stage mast and attached tripod.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is an exemplary portable work light in a deployed position.

FIG. 2 illustrates an exemplary balloon light fixture/lamp with an inflatable diffuser.

FIG. 3 is the exemplary portable work light in a collapsed position.

FIG. 4 is a front prospective of a collapsed portable work light.

FIGS. 5 and 6 illustrate the cavity of the turtle shell.

FIG. 7 illustrates the collapsible poles positioned within the cavity with a drawstring closure surrounding the cavity.

FIG. 8 illustrates a lower portion of the turtle shell.

FIG. 9 illustrates a bottom of the turtle shell.

FIG. 10 illustrates a perspective view of the turtle shell.

FIG. 11 illustrates a side view of the turtle shell.

FIG. 12 illustrates a top view of the turtle shell.

FIG. 13 illustrates a top view of the turtle shell.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

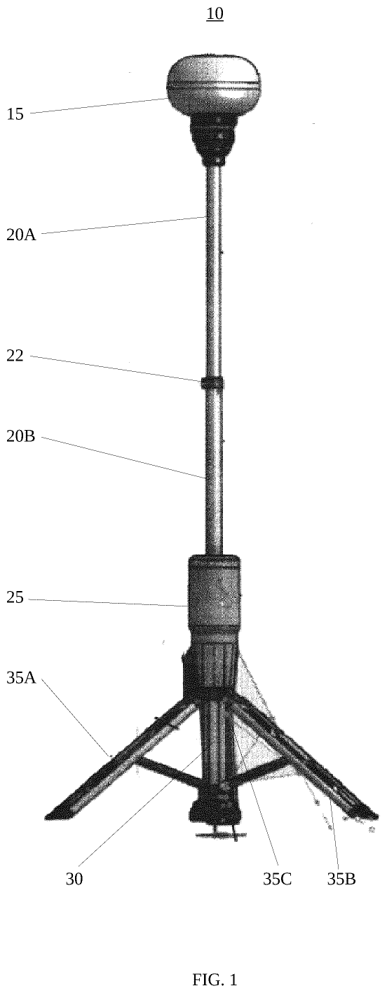

A portable work light with a translucent, inflatable, fabric balloon diffuser was described in U.S. Pat. No. 11,287,103 issued on Mar. 29, 2022, owned by the Applicant, ISM Lighting, Inc., and U.S. Pat. No. 11,287,103 is incorporated by reference in its entirety. Referring now to FIG. 1, an exemplary portable work light 10 is shown in a deployed position and includes a balloon light fixture/lamp with an inflatable diffuser 15 resting on a set of collapsible telescoping poles 20A, 20B joined together by a locking clamp 22. A lower pole 20B is slidably engaged into a housing 25, hereinafter referred to as a “turtle shell.” The turtle shell 25 rides up and down on a tube 30, preferably a hex tube. In one embodiment, three legs 35A, 35B, 35C are pivotally attached to bottom ends of the turtle shell 25, and provide a tripod configuration for stability.

As is explained in more detail below, the housing 25 is a turtle shell because its operation is analogous to how a turtle's head retracts into its shell for protection or extends out of the shell. More specifically, turtles retract their heads using flexible necks and specialized vertebrae, allowing them to pull their heads inside their shells for protection. Most turtles, pull their heads straight back into their shells.

The turtle shell 25 operates in a similar manner wherein the balloon light fixture/lamp with an inflatable diffuser 15 rests on the set of collapsible telescoping poles 20A, 20B out of the turtle shell 25 when in a deployed state, while the balloon light fixture/lamp with an inflatable diffuser 15 and the set of collapsible telescoping poles 20A, 20B collapse into the turtle shell 25 in a collapsed state. In this collapsed position, the balloon light fixture/lamp with an inflatable diffuser 15 is fully protected from the environment and a risk of damage. In summary, collapsed state, the balloon light fixture/lamp with an inflatable diffuser 15 is nested within the turtle shell 25.

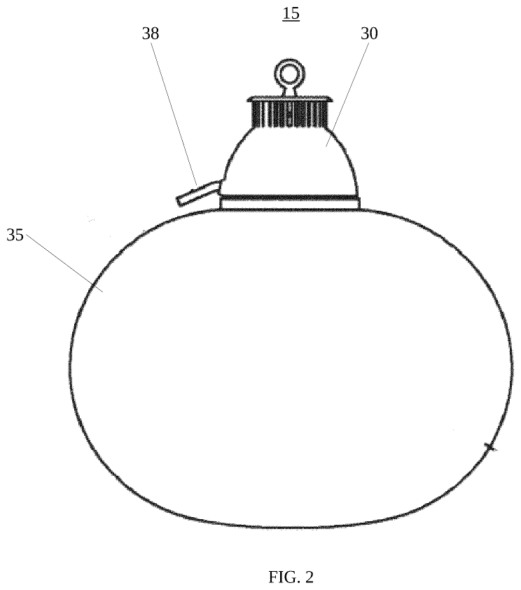

As shown in FIG. 2, in one embodiment, the balloon light fixture/lamp with an inflatable diffuser 15 includes an illumination unit 30, an inflatable balloon 35, and a link 38 to a power source. The power source may be a battery, an AC/DC outlet or a combination of both. In embodiments, the illumination unit 30 can include an LED light bank (not shown). In embodiments, the balloon light fixture/lamp with an inflatable diffuser 15 may include a fan (not shown) where fan-forced air is useful for cooling the LED light bank during operation. The fan may also be used to inflate and cool a heat sink.

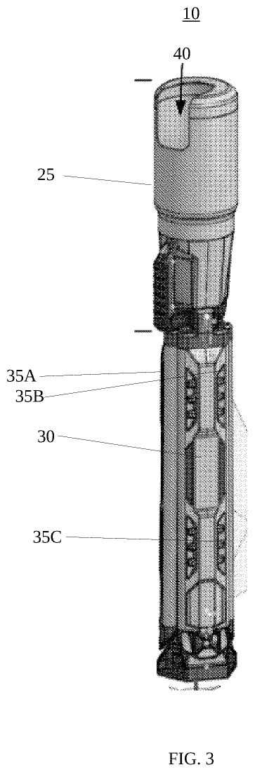

As shown in FIG. 3, the portable work light 10 is shown in a collapsed position with the legs 35A, 35B, 35C rotated up against the hex tube 30 and the collapsible telescoping poles 20A, 20B and balloon light fixture/lamp with an inflatable diffuser 15 withdrawn into a cavity 40 at a top of the turtle shell 25 for protection, transport and storage.

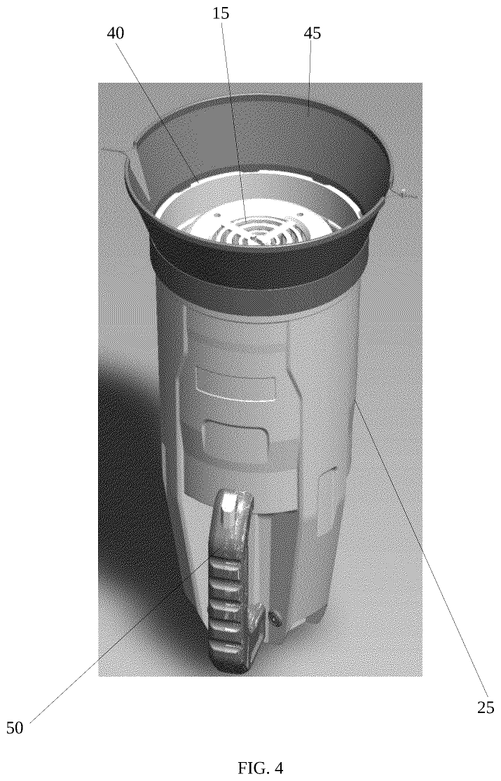

In FIG. 4, a front prospective of the collapsed portable work light 10 is shown. Here, a top of the balloon light fixture/lamp with an inflatable diffuser 15 is positioned within the cavity 40, where components of the balloon light fixture/lamp with an inflatable diffuser 15, i.e., illumination unit, collapsed inflatable balloon, and link 38 to the power source, are nested and protected. In the embodiment shown in FIG. 4, a top of the includes an optional drawstring closure 45 that can be manually tightened to provide extra protection to the components of the balloon light fixture/lamp with an inflatable diffuser 15 when nested within the turtle shell 25.

In one embodiment, the turtle shell 25 includes a handle 50 that is used to transport the collapsed portable work light 10 from location to location.

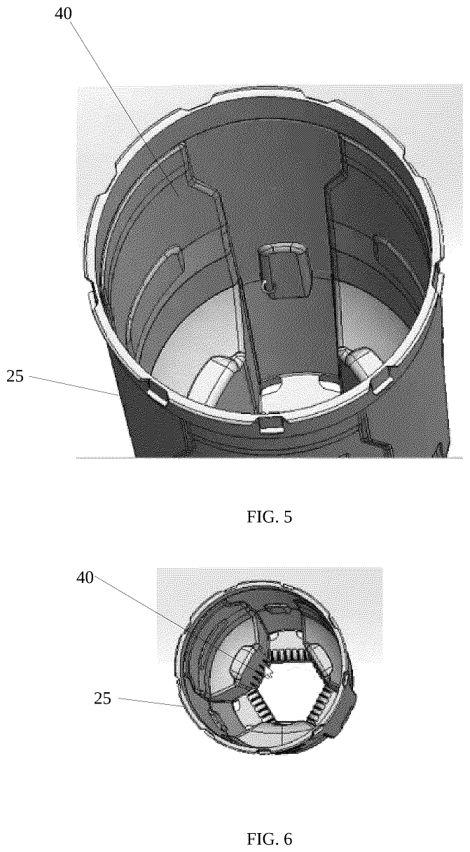

FIGS. 5 and 6 illustrate the cavity 40 of the turtle shell 25 that provides a nesting location for the balloon light fixture/lamp with an inflatable diffuser 15 in collapsed position.

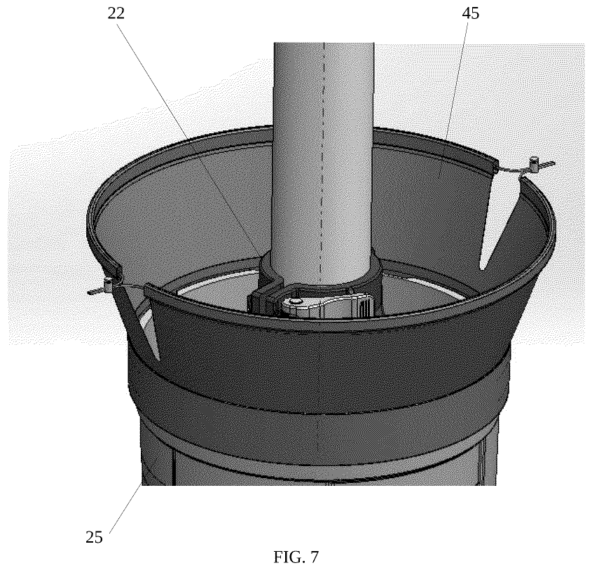

FIG. 7 illustrates the collapsible poles positioned within the cavity with the drawstring closure 45 surrounding the cavity 40.

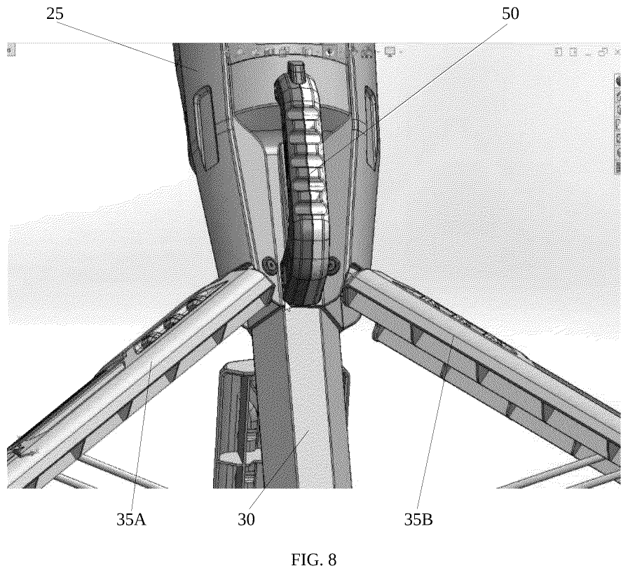

FIG. 8 illustrates a lower portion of the turtle shell 25 in a deployed state that includes legs 35A, 35B, the hex tube 30 and the handle 50.

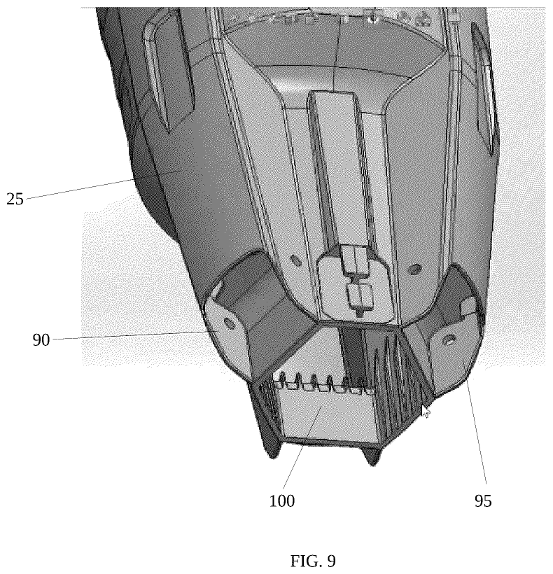

FIG. 9 illustrates a bottom of the turtle shell 25 that includes a leg attachment 90, a leg attachment 95 and an opening 100 for the hex tube 30. An additional leg attachment is located on an opposite side not shown in this figure.

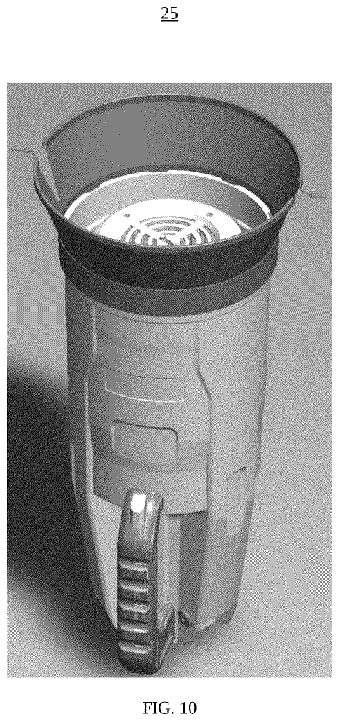

FIG. 10 illustrates a perspective view of the turtle shell.

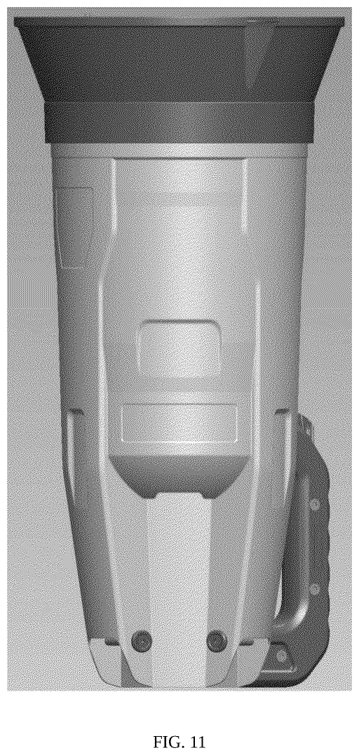

FIG. 11 illustrates a side view of the turtle shell.

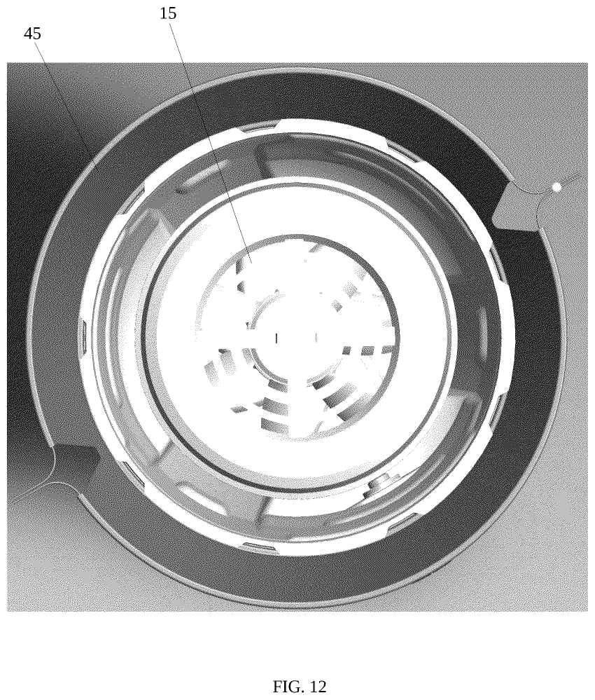

FIG. 12 illustrates a top view of the turtle shell.

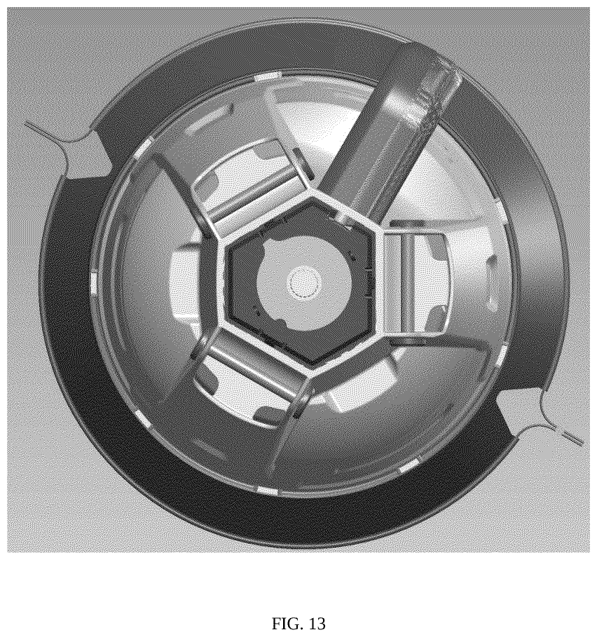

FIG. 13 illustrates a top view of the turtle shell.

In operation, to deploy the balloon light fixture/lamp with an inflatable diffuser 105 from a collapsed configuration to a deployed configuration, balloon light fixture/lamp with an inflatable diffuser 105 is withdrawn from the cavity 40 via the top of the turtle shell 25 and collapsible telescoping poles 20A, 20B are drawn upward from tube 30 and locked in place by the clamp 22. Concurrently, turtle shell 25 is slid downward on tube 30 causing the legs 35A, 35B, 35C to fan out and deploy.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A portable work light comprises:
a balloon light fixture/lamp with an inflatable diffuser resting on a set of collapsible telescoping poles locked together by a locking clamp;
a turtle shell housing, a lower collapsible telescoping pole engaged within a cavity of the turtle shell housing;
a tube, the turtle shell housing configured to ride up and down on the tube; and
legs pivotally attached to bottom ends of the turtle shell and fanned out from the tube,
the turtle shell housing configured to:
receive collapsed collapsible telescoping poles when the clamp is unlocked;
receive the balloon light resting on the set of collapsible telescoping poles; and
receive the legs in a collapsed state.

2. The portable work light of claim 1 wherein the tube is hexagonal.

3. The portable work light of claim 1 wherein the cavity includes a drawstring closure positioned on its upper perimeter.

4. The portable work light of claim 1 wherein the balloon light fixture/lamp with an inflatable diffuser comprises:
an illumination unit;
an inflatable balloon; and
a link to a power source.

5. The portable work light of claim 4 wherein the power source may be a battery, an AC/DC outlet or a combination of both.

6. The portable work light of claim 4 wherein the illumination unit comprises a Light Emitting Diode (LED) light bank.

7. The portable work light of claim 4 wherein the balloon light fixture/lamp with an inflatable diffuser further comprises a fan.

8. A portable lighting system comprising:
a balloon light fixture/lamp with an inflatable diffuser mounted on a telescoping mast; and
a turtle shell housing with a cavity to enclose and protect the balloon light when in a collapsed state.

9. The portable lighting system of claim 8 wherein the turtle shell housing further comprises a tube slidably engaged with the turtle shell housing for sheathing the telescoping mast.

10. The portable lighting system of claim 8 wherein the turtle shell housing further comprises a clamp for maintaining the mast sections in an extended position.

11. The portable lighting system of claim 8 wherein the turtle shell housing further comprises legs pivotally attached to the base of the turtle shell housing.

12. The portable lighting system of claim 8 wherein the turtle shell housing further comprises linkages attached to an end cap on the lower portion of the tube.

13. The portable lighting system of claim 8 wherein the turtle shell housing further comprises integrated handle.

14. A turtle shell housing comprising:
an upper cavity configured to receive and protect a balloon light fixture/lamp with an inflatable diffuser mounted on a telescopic tube in a collapsed position and support the balloon light on the telescopic tube in a deployed position;
a lower cavity configured to receive a hex tube; and
a plurality of leg attachments positioned around a lower perimeter.

15. The turtle shell housing of claim 14 wherein balloon light fixture/lamp with an inflatable diffuser comprises:
an illumination unit;
an inflatable balloon; and
a link to a power source.

16. The turtle shell housing of claim 14 wherein the plurality of leg attachments are configured to receive pivotally attached legs.

17. The turtle shell housing of claim 14 wherein the lower cavity is further configured to enable the hex tube to slide up and down withing the housing.

18. A turtle shell housing comprising:
a solid cylindrical structure configured to:
shield a balloon light fixture/lamp with an inflatable diffuser when in a retracted position; and
store a two-stage mast and attached tripod.

19. The turtle shell housing of claim 18 wherein the two-stage mast is configured to extend and lower the balloon light fixture/lamp with an inflatable diffuser for increased light area coverage.

20. The turtle shell housing of claim 18 wherein a top of the solid cylindrical structure includes a closure.

21. The turtle shell housing of claim 20 wherein the closure is configured to aid with deflated balloon diffuser management including prevention of water and dust ingress.

22. The turtle shell housing of claim 21 wherein the closure includes a drawstring.

23. The turtle shell housing of claim 20 wherein the closure is a textile fabric with a drawstring.

24. The turtle shell housing of claim 18 wherein the solid cylindrical structure is an injection molded plastic configured for rugged and abusive environments, exposure during transportation, and protection from impacts or drops.

25. The turtle shell housing of claim 18 wherein the solid cylindrical structure includes a bottom drain configured for water ingress.
